(19) United States
(12) Patent Application Publication
(10) Pub. No.: US 2010/0064985 A1
(43) Pub. Date: Mar. 18, 2010

(54) DEVICE FOR TAGGING AN ANIMAL AND A MAGAZINE WITH TAGS FOR USE IN SUCH DEVICE

(76) Inventors: Henrik Jacobsen, Maribo (DK); Jesper Blok, Billund (DK)

Correspondence Address: GIFFORD, KRASS, SPRINKLE,ANDERSON & CITKOWSKI, P.C, PO BOX 7021, TROY, MI, 48007-7021, US

(21) Appl. No.: 12/522,777

(22) PCT Filed: Jan. 10, 2008
(86) PCT No.: PCT/DK2008/050005

§ 371 Date: Oct. 5, 2009

(30) Foreign Application Priority Data
Jan. 12, 2007 (DK) PA 2007 00047

(51) Int. Cl. A01K 11/00; G09F 3/12; B65H 99/00

(52) U.S. Cl. 119/858; 40/301; 221/199

(57) ABSTRACT

The present invention concerns an automated ear tagging device for tagging an animal. Pre-filled magazines with ear tag elements are loaded into the device whereby a quick and easy tagging of a large amount of animals may be carried out. Thereby an ear tagging device is provided for easing and minimising the workload in attaching ear tags, in particular circular ear tags on piglets and slaughter pigs, but also other livestock animals.

The present invention relates to a device and a method for tagging an animal and a magazine with tags for use in such device and method.

Domestic animals, such as calves, cattle, pigs, sheep and goats or similar livestock, are to an extensive degree ear tagged for e.g. to provide identification such as indications concerning ownership, medical treatment, nutritional diet control, etc. This may be done by applying a unique tag code to the animal. In particular, in the industrialised animal farming, such as pig farming, ear tagging is an important factor in stable management, breeding and at least equally as important in relation to a national veterinary point of view and livestock origin. The ear tagging of the animals may be used for identifying the individual animals both nationally and internationally.

The ear tags comprise a male tag element and a female tag element, where the male tag element is pierced through the animal's ear and attaching said male tag element to the associated female tag element.

Today, the most common manner of attaching the ear tags is by using a tagging applicator, such as disclosed in WO 02/078431, where the male part of the tag is placed in one jaw and the female part in the other jaw where after the applicator is positioned with the jaws on each side of the ear and then the jaws are pressed together for attaching the tag. The tagging applicator is handheld.

However, since modern pig breeding and pig farming requires the tagging of thousands of animals per week, this manner of tagging is time consuming and cumbersome work. This ear tagging work may in combination with the instinctive of the animals result in maltagging, such as wrong position of the ear tag, placing of the tag in a blood vein, which can add negatively to the animal welfare.

To avoid having to apply new tag elements before each tagging, there is also known automated tagging applicators, see for instance U.S. Pat. No. 6,053,926, where a number of tag elements are placed in magazines before the tagging operation.

However, with a high amount of animals for tagging, it is the object of the invention to provide a device for ear tagging an animal which is easy to use and eases the work load associated with ear tagging.

The object is achieved by a device for attaching ear tags to an animal, wherein the ear tags comprise a male tag element and a female tag element, said device comprising a housing comprising a receiving slot with an attachment means for forwarding a male tag element through the animal's ear and attaching said male tag element to the associated female tag element, a first magazine on the first side of said receiving slot and a first stop for retaining the first magazine in a predetermined position in the housing relative to the attachment means, a second magazine on the second side of said receiving slot and a second stop for retaining the second magazine in a predetermined position in the housing relative to the attachment means, wherein the first magazine comprises male tag elements arranged on a carrier member and the housing further comprises means for forwarding the first magazine towards the first stop, and the second magazine comprises female tag elements arranged on a carrier member and the housing further comprises means for forwarding the second magazine towards the second stop.

In a preferred embodiment of the device the male tag elements and/or the female tag elements are arranged on their respective carrier member in a substantially linear configuration. Furthermore, each of the first and second magazine forwarding means preferably comprises a spring-loaded pusher capable of pushing at a rear end the carrier member of the magazine so that the tag element at the opposite end of the carrier member is abutting the stop.

In a preferred embodiment a first magazine loading opening and a first magazine carrier member outlet opening are provided, and wherein there is a path between said two openings, where said path has a substantially linear portion leading up to the attachment means for guiding the first magazine carrier member.

Similarly, a second magazine loading opening and a second magazine carrier member outlet opening are provided, and wherein there is a path between said two openings, where said path has a substantially linear portion leading up to the attachment means for guiding the second magazine carrier member.

A second embodiment of the device according to the invention comprises means for applying a variable force to a male tag when said male tag is forwarded through the animal's ear and attached to the associated female element. The variable force can be applied by providing the lever arrangement with a self changing two gear transmission. The advantage of this design is that it has low force and high speed in the beginning, switching to high force and low speed when the high force is needed to pierce trough the ear of the animal and interlock with the associated female part. This embodiment of the device has a quick retract function that lets the piston retract without releasing the handle. The retracting force is preferably provided by a spring. This retract function provides that the device automatically releases subsequent to attaching the ear tag, i.e. any grip of the animal's ear provided by the device is automatically released immediately following attaching the ear tag. Furthermore, the device can reload before the handle is released. Without the automatic retract function the device is attached to the animal ear until the handle is released. Thereby the device can be pulled out of the hand of the user by an animal moving the head before the handle is released and possibly causing damage to the animal's ear.

By the present invention, there is provided an ear tagging device for easing and minimising the workload in attaching ear tags, in particular circular ear tags on piglets and slaughter pigs, but also other livestock animals.

The present invention concerns an automated ear tagging device for tagging an animal. Pre-filled magazines with ear tag elements are loaded into the device whereby a quick and easy tagging of a large amount of animals may be carried out.

The invention is disclosed in more detail with reference to the accompanying drawings, in which:

FIG. 1 is a perspective view of an ear tagging device according a preferred embodiment of the invention,

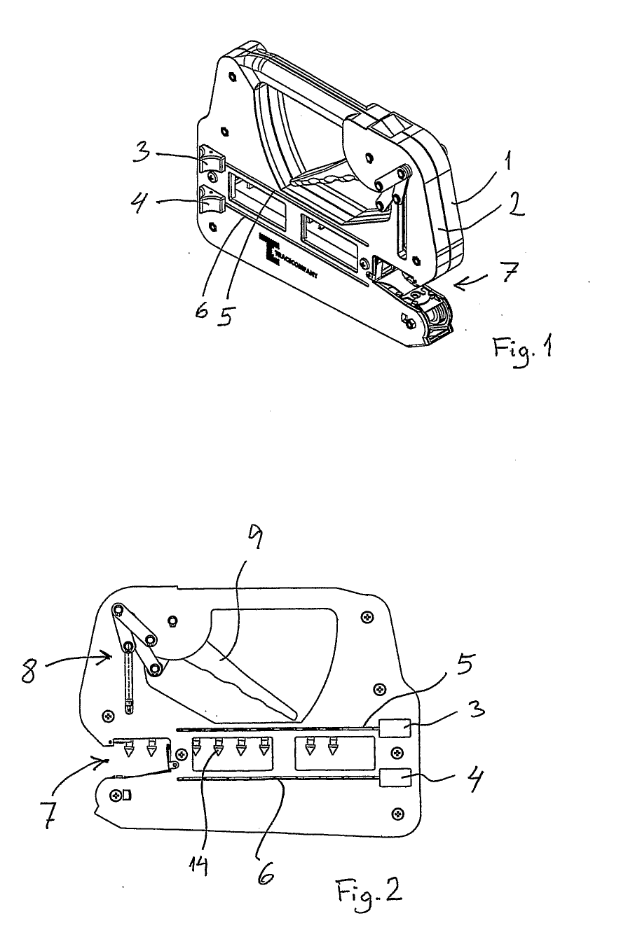

FIG. 2 is a side view of the ear tagging device in FIG. 1,

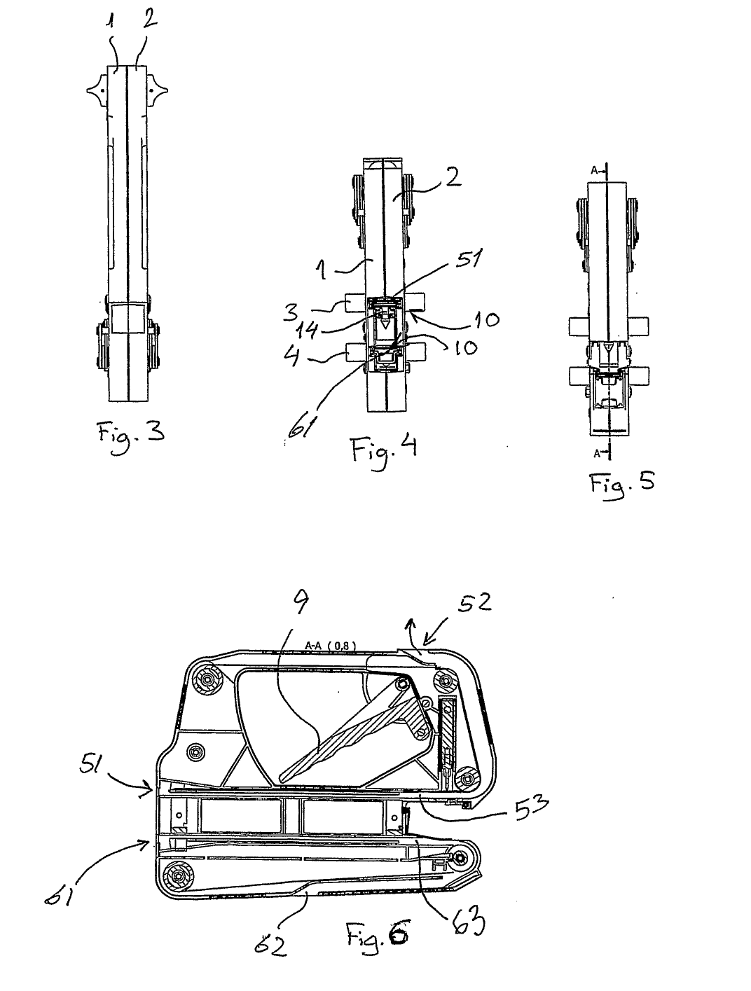

FIG. 3 is a top view thereof,

FIG. 4 is an end cut-away view of the front of the ear tagging device in FIG. 1,

FIG. 5 is an end view of the front end of the ear tagging device in FIG. 1,

FIG. 6 is a cross-section side view of the ear tagging device in FIG. 1,

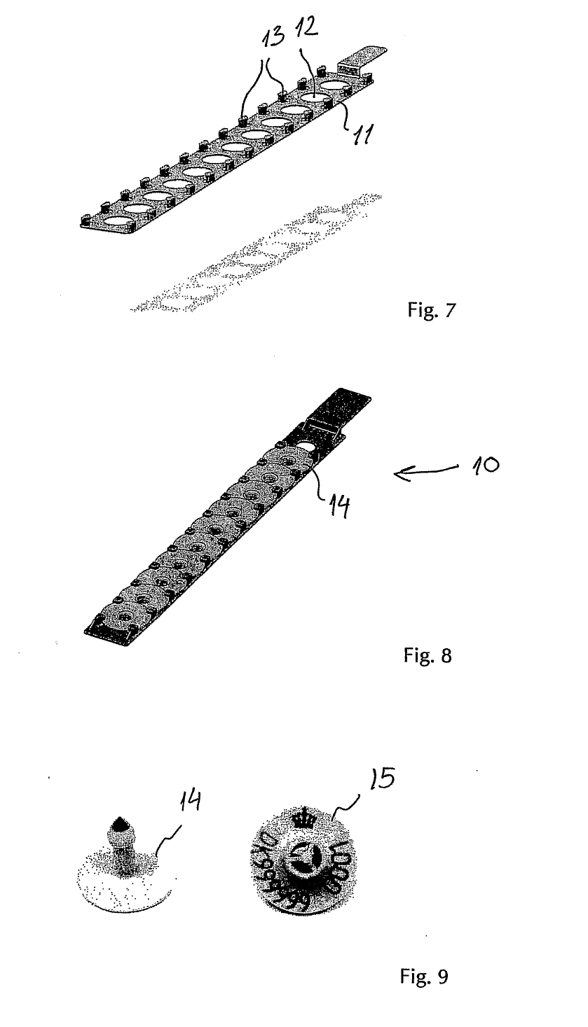

FIG. 7 is a perspective view of a magazine carrier member according to a preferred embodiment of the invention,

FIG. 8 is a perspective view of a magazine carrier member preloaded with tag elements;

FIGS. 9 a) and b) show a male and a female tag element for use in a magazine, and

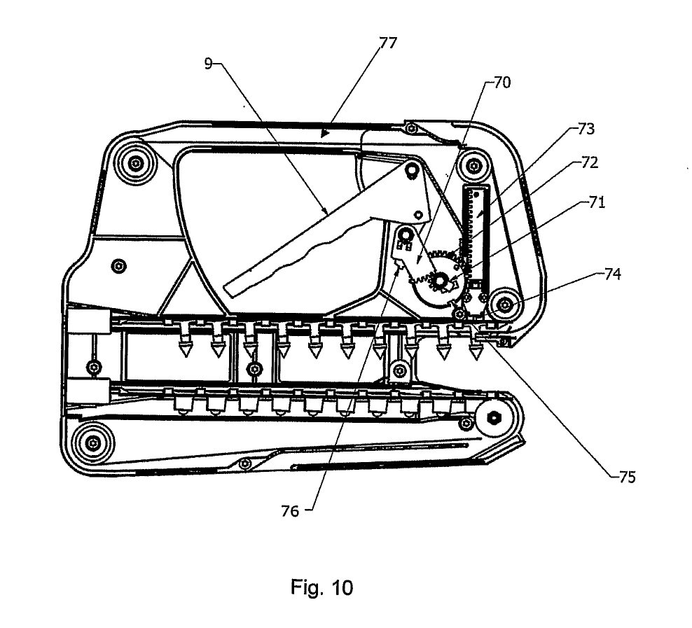

FIG. 10 is a cross-section side view of a second embodiment of the invention.

With reference to the figures, the magazine carrier members 11 are produced in a flexible material, such as plastic or another disposable material, with a flat carrier member 11 with a plurality of tag receiving openings (apertures) 12 arranged in series therein. Associated with each opening there are provided a tag element retaining protrusions 13. Thereby tag elements 14 of the same kind can be arranged in series on the carrier member 11. The magazine carrier members 11 are preferably strips, such as guide strips, as illustrated in FIGS. 7 and 8. The magazine carrier member 11 may be moulded by ejection moulding, vacuum forming or the like, whereby an inexpensive manufacture of the tag element magazines is provided.

The ear tagging device comprises a housing made up by two parts 1 and 2. In a preferred embodiment of the invention two spring-loaded loading members 3 and 4 are arranged for linear movement within two guide tracks 5, 6 having essentially the same orientation as the magazines 10.

Both the upper and lower guide tracks 53, 63 extend from a magazine entry 51 and 61, respectively, to a magazine carrier member outlet 52, 62, respectively. The magazine 10 in the upper path 53 contains male tag elements 14 with the pin portion thereof pointing downwards. In the shown embodiment the tag elements 14 are partially overlapping thereby improving the packing efficiency of the magazine 10. The tag elements 14 might as well be arranged side by side in the magazine 10 without overlapping. The magazine 10 in the lower path 63 contains the corresponding female tag elements 15. The magazines 10 are loaded into the tagging device at the inlets 51, 61 when the two spring-loaded charging pushers 3, 4 are pulled back along the guide tracks 5, 6. After the magazines are loaded into the device, the pushers 3, 4 are then released whereby the magazines 10 are pushed forward against a stop.

The paths 53 and 63 include essentially linear portions which terminate at the attachment means 8 on each side of the ear receiving slot 7 of the device. When the handle 9 is operated, a lever arrangement is activated and a piston is pushed downwards and catches the forward-most male ear tag element of the upper magazine 10 which thereby is released from the magazine carrier member by this piston pressing and pierced through the animal's ear (which prior to operating the device is inserted into the receiving slot 7) and locked in the underlying female tag element. After the locking, the handle 9 is released and the piston retracts and the device is moved relative to the animal whereby the female tag element including the male tag element is freed from the device. Afterwards, the springs in the pusher arrangement presses the pushers 3, 4 and thereby the magazines 10 in the upper and lower paths forward so that the device is reloaded automatically for the next tagging operation.

Since the magazine carrier member 11 when emptied for tag elements is pushed along guide rollers in the upper and lower paths for when emptied to be discharged from the device through the outlets 52, 62.

When the empty magazines 10 are discharged, the empty carrier members 11 can be disposed and a set of new magazine carrier member with tag elements loaded into the device.

In the figures the magazine carrier member 11 is shown loaded with ten tag elements 14. The invention is not limited to a certain number of tag elements 14 in the magazine carrier member 11. In one embodiment of the invention the magazine carrier member 11 is substantially “endless”, i.e. there is no clear separation between magazines.

In another embodiment of the invention the tag elements are punched out of the magazine carrier member. Thereby a magazine carrier member including tag elements is manufactured in fewer steps compared to the first embodiment of the invention wherein the magazine carrier members and the tag elements are manufactured separately and subsequently assembled.

In a further embodiment of the invention the magazine carrier member is substantially circular and disc-like. Thus, the tag elements are placed on the magazine carrier member next to each other in a circle. By having a spiral shaped magazine carrier member an almost true “endless” feeding is provided to the ear tagging device according to the invention. After loading the ear tagging device with a spiral shaped magazine carrier member, reloading would hardly be necessary and the efficiency of the process of ear tagging animals would be greatly enhanced. An “endless” linear magazine carrier member would be limited by space requirements unlike a spiral shaped magazine carrier member. A spiral shaped magazine carrier member would only require an area corresponding to the diameter of the spiral. A further embodiment of the invention could be a spiral shaped magazine carrier member with punched out tags.

FIG. 10 shows a second embodiment of the device according to the invention. The handle 9 and the gear part 70 form a hinged joint, whereby a force applied to the handle 9 by lifting said handle 9 towards the bar 77 is transferred to a rotation of the gear part 70, i.e. a compressing force applied to the handle 9 is transferred to a rotation of the gear part 70. When the handle 9 is operated (turned clockwise towards the bar 77) the gear part 70 is turned counter clockwise. This rotation is transmitted to gearwheel 71 that is attached to the large gearwheel 72. Gearwheel 72 is moving the piston 73 down thereby placing the needle 74 in the centre hole of the male tag and forcing it down towards the female tag. At this point the piston 73 is moving at a ratio approximately 3 to 6 times faster than the handle 9. When the handle 9 is turned so far that the gear part 70 and gearwheel 70 are rotated to the position where they do not interlock in the gear, the locking pin 76 is pressed into the groove 75 in the gearwheel 72. From this point the piston 73 is moving at a ratio of approximately 1 to 1.5 times faster than the handle 9. When the handle 9 is fully activated the locking pin 76 is forced out of the groove 75. When the piston 73 is no longer forced downwards it is moved up to its start position by a spring without moving the handle 9, i.e. the automatic release of the device is provided by the locking pin 76 and a spring. By releasing the handle 9 the rest of the system moves back in the start position ready for the next cycle.

1-22. (canceled)

23. A device for attaching ear tags to an animal, wherein the ear tags comprise a male tag element and a female tag element, said device comprising
a housing comprising a receiving slot with an attachment means for forwarding a male tag element through the animal's ear and attaching said male tag element to the associated female tag element;
a first magazine on the first side of said receiving slot and a first stop for retaining the first magazine in a predetermined position in the housing relative to the attachment means, said first magazine comprises male tag elements arranged on a carrier member and the housing further comprises means for forwarding the first magazine towards the first stop;
a second magazine on the second side of said receiving slot and a second stop for retaining the second magazine in a predetermined position in the housing relative to the attachment means, said second magazine comprises female tag elements arranged on a carrier member and the housing further comprises means for forwarding the second magazine towards the second stop; and
a self changing two gear transmission operable to apply a variable force to a male tag element when said male tag element is forwarded through the animal's ear and attached to the associated female tag element.

24. A device according to claim 23, wherein the male tag elements and/or the female tag elements are arranged on their respective carrier member in a substantially linear configuration.

25. A device according to claim 24, wherein each of the first and second magazine forwarding means comprises a spring-loaded pusher capable of pushing a rear end the carrier member of the magazine so that the tag element at the opposite end of the carrier member is abutting the stop.

26. A device according to claim 23, wherein a first magazine loading opening and a first magazine carrier member outlet opening are provided, and wherein there is a path between said two openings, where said path has a substantially linear portion leading up to the attachment means for guiding the first magazine carrier member.

27. A device according to claim 23, wherein a second magazine loading opening and a second magazine carrier member outlet opening are provided, and wherein there is a path between said two openings, where said path has a substantially linear portion leading up to the attachment means for guiding the second magazine carrier member.

28. A device according to claim 23, furthermore comprising means for automatically releasing the device subsequent to attaching the ear tag, whereby the device no longer grips the animal's ear.

29. A device according to claim 28, wherein the means for automatically releasing the device comprises a spring and/or a locking pin.

30. A device according to claim 23, furthermore comprising a hinged joint for transferring a compressing force into a rotation of a gear part.

31. A magazine with tags for an ear tagging device, said magazine comprising a carrier member of a flexible material provided with a number of apertures in which tag elements of the same kind are arranged in series, wherein the tag elements are partially overlapping.

32. A magazine according claim 31, wherein the carrier member is a strip.

33. A magazine according to claim 31, comprising a circular disc-like magazine carrier member.

34. A magazine according to claim 31, wherein the magazine carrier member is a spiral.

35. A magazine according to claim 31, wherein the magazine carrier member is disposable after the tag elements have been used.

36. A method for attaching ear tags to an animal, wherein the ear tags comprise a male tag element and a female tag element, said method comprising the steps of
applying a variable force to a male tag element by means of a self changing two gear transmission, when forwarding said male tag element through the animal's ear and attaching said male tag element to the associated female tag element, said male tag element attached in a receiving slot in a housing;
retaining a first magazine in a predetermined position in the housing relative to the attachment means by means of a first stop, said first magazine located on the first side of said receiving slot, and
retaining a second magazine in a predetermined position in the housing relative to the attachment means by means of a second stop, said second magazine located on the second side of said receiving slot,
forwarding the first magazine in the housing towards the first stop, said first magazine comprising male tag elements arranged on a carrier member, and
forwarding the second magazine in the housing towards the second stop, said second magazine comprising female tag elements arranged on a carrier member.

37. A method according to claim 36, wherein the first and/or the second magazine is a magazine comprising a carrier member of a flexible material provided with a number of apertures in which tag elements of the same kind are arranged in series, wherein the tag elements are partially overlapping.

38. A method according to claim 36, wherein the male tag elements and/or the female tag elements are arranged on their respective carrier member in a substantially linear configuration.

39. A method according to claim 36, wherein a compressing force is transferred to a rotation of a gear part by means of a hinged joint.

40. A method according to claim 36, wherein any grip to the animal's ear is automatically released subsequent to attaching the ear tag.
